(19) United States
(12) Patent Application Publication
(10) Pub. No.: US 2014/0338548 A1
(43) Pub. Date: Nov. 20, 2014

(54) ROUND BALER WRAPPING WITH MULTIPLE STATIONARY STRANDS

(71) Applicant: AGCO Corporation, Duluth, GA (US)

(72) Inventors: Brian Olander, Buhler, KS (US); Robert Matousek, Valley Center, KS (US)

(21) Appl. No.: 14/368,045

(22) PCT Filed: Dec. 24, 2012
(86) PCT No.: PCT/US2012/071568

§ 371 Date: Jun. 23, 2014

Related U.S. Application Data
(60) Provisional application No. 61/578,947, filed on Dec. 22, 2011.

(51) Int. Cl. A01F 15/14

(52) U.S. Cl. CPC A01F 15/141
USPC 100/3; 53/587; 100/15

(57) ABSTRACT

A wrapping arrangement for a baler is configured to provide a plurality of twine strands perpendicular to the longitudinal axis of the bale from stationary positions relative the bale. A guide arrangement routes twine strands to align with forming belts of a baler and a feed mechanism feeds the twine strands into a baling chamber through contact with the bale forming belts. In one arrangement two twin strands are provided to each forming belt.

### BACKGROUND OF THE INVENTION

1. Field of the Invention

This invention pertains generally to methods and systems for wrapping a bale in a round baler, and more particularly to bale wrapping with twine.

2. Background

Typical twine application systems for round balers consist of 1 or 2 strands of twine that are moved by a mechanism back and forth longitudinally across the bale chamber to wrap the bale across the bale's entire width. This arrangement not only requires a complicated movable mechanism that is subject to malfunction but wrapping in this manner is time intensive as it takes many revolutions of the bale to complete the wrapping process as the arms move across the bale. For example, under such prior art movable arm systems, wrapping a 5 foot wide bale at a twine spacing of 3.5″ takes approximately 25 seconds with 10.5 bale revolutions. The larger width the bale the longer the wrapping process as the twine arms move along the length of the bale. Because the formation of a new bale typically does not begin until completion of bale wrapping, decreasing bale wrapping time would result in increased productivity.

### SUMMARY OF THE INVENTION

In an example embodiment, a bale wrapping system is configured to apply a plurality of parallel spaced-apart twine strands perpendicular to the longitudinal axis of a bale in a baling chamber of a baler. The twine strands are stationary in the sense that they are not moved along the bale but are applied at a single position to the bale. In an example embodiment, a plurality of twine strands are routed through a plurality of stationary positioners provided on a manifold that extends across the rear of a baling chamber to align the twine strands with the bale forming belts of a baler. The positioners may be arranged so that the twine strands are gripped by the bale forming belts to wrap the bale with a plurality of parallel twine strands perpendicular to the longitudinal axis of the bale formed in the baling chamber. This arrangement allows a bale in the baling chamber to be wrapped in fewer revolutions than prior art systems resulting in a significant time savings over traditional 2-twine wrapping techniques. Further, the use of stationary guides eliminates the movement of the twine strands longitudinally along the bale and the related mechanisms for doing so. Furthermore, the system may be used to apply meshwrap as well as twine.

In one example embodiment, a bale wrapping system includes a housing having storage for a twine source, such as twine balls; a feed mechanism for feeding twine strands from the twine balls to a baling chamber of a baler; and a guide arrangement having stationary positioners to provide the twine strands to the feed mechanism in such a manner that the twine strands are aligned with the forming belts of the baler. This arrangement prevents the twine strands from getting between the bale forming belts and provides parallel spaced apart separate twine wraps that do not need knotting and require fewer revolutions of the bale. For use with large balers in which a large number of twines may be desired, additional twine balls may be provided in side cabinets of the baler. Twine strands from these cabinet twine balls may be and routed through a guide arrangement, to the manifold, and to the bale forming belts.

The twine strands may be routed through the positioners to a feed mechanism in a parallel spaced apart condition for aligning with bale forming belts. The feed mechanism may include a feed roller provided on a rockable carriage. The carriage may be rocked between a feed condition in which a nip is created between the feed roller and bale forming belts to feed the twine strands to the bale chamber of the baler to wrap the bale, and a non-feed position in which the feed roller is disengaged from forming belts. A cutoff mechanism may also be provided to cut the twine strands after bale wrapping.

In one example embodiment, a manifold is arranged to have a plurality of positioners configured to provide a plurality of twine strands to a bale forming belt. For example, in one example embodiment a guide arrangement provides two twine strands per bale forming belt at a spacing of about 3.5″. In one such arrangement, the positioners may be configured to provide 24 strands spaced about 3.5″ apart for an eight foot wide bale in which two twine strands are provided to each of 12 bale forming belts. In an example embodiment in which 16 twines are applied to 8 forming belts a 5 foot bale, a bale may be wrapped by a plurality of aligned twine strands from stationary positioners in about 10 seconds.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 shows a right rear perspective view of an example embodiment of a baler having a multi-twine wrap system;

FIG. 2 shows a left rear view of an example embodiment of a baler having a multi-twine wrap system;

FIG. 3 shows a rear view of an example embodiment of a baler having a multi-twine wrap system;

FIG. 4 shows an example embodiment of a multi-twine wrap system for use with a round baler;

FIG. 5 shows a right rear perspective view of a round baler having a multi-twine wrap system in a feed position showing the path of a twine strand;

FIG. 6 shows a left rear view of a round baler having a multi-twine wrap system showing the path of a twine strand from a side cabinet;

FIG. 7 shows a right side view of an example embodiment of a multi-twine wrap system in a feed position;

FIG. 8 shows a right side view of an example embodiment of a multi-twine wrap system in a cutoff position;

FIG. 9 shows a right side view of an example embodiment of a multi-twine wrap system in a cutoff position;

FIG. 10 shows an example embodiment of a bale wrapped using the multi-twine wrap system;

FIG. 11 shows a right rear view of an example embodiment of a small round baler having a multi-twine wrap system; and

FIG. 12 shows a rear view of the small round baler of FIG. 11.

Corresponding reference characters indicate corresponding parts throughout the views of the drawings.

### DESCRIPTION OF EXAMPLE EMBODIMENTS

As required, example embodiments of the present invention are disclosed herein. The various embodiments are meant to be non-limiting examples of various ways of implementing the invention and it will be understood that the invention may be embodied in alternative forms. The present invention will be described more fully hereinafter with reference to the accompanying drawings in which like numerals represent like elements throughout the several figures, and in which example embodiments are shown. The figures are not necessarily to scale and some features may be exaggerated or minimized to show details of particular elements, while related elements may have been eliminated to prevent obscuring novel aspects. The specific structural and functional details disclosed herein should not be interpreted as limiting, but merely as a basis for the claims and as a representative basis for teaching one skilled in the art to variously employ the present invention.

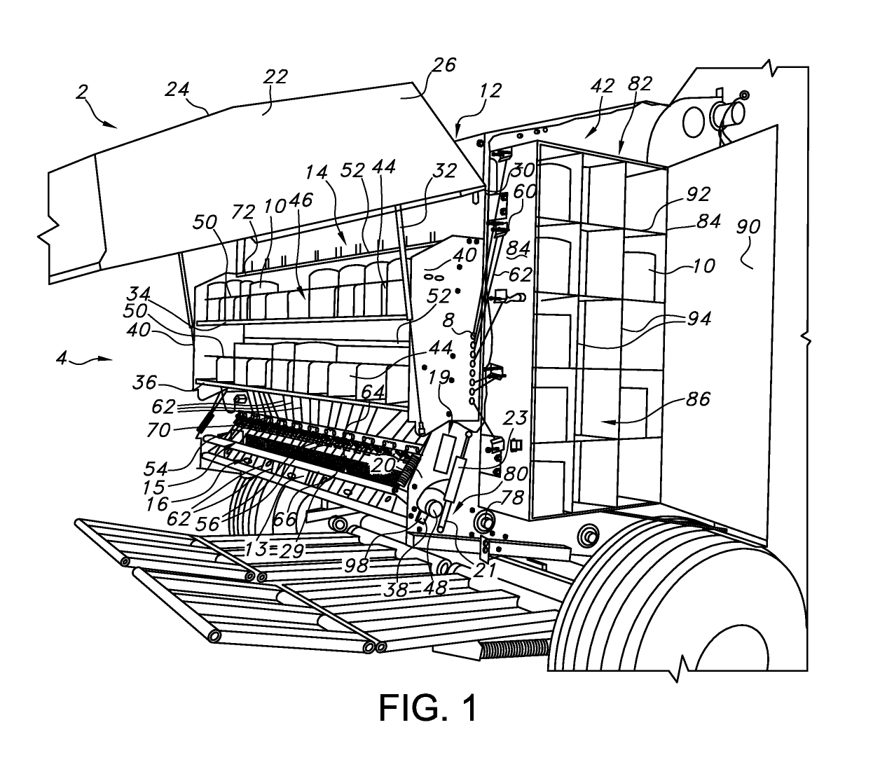

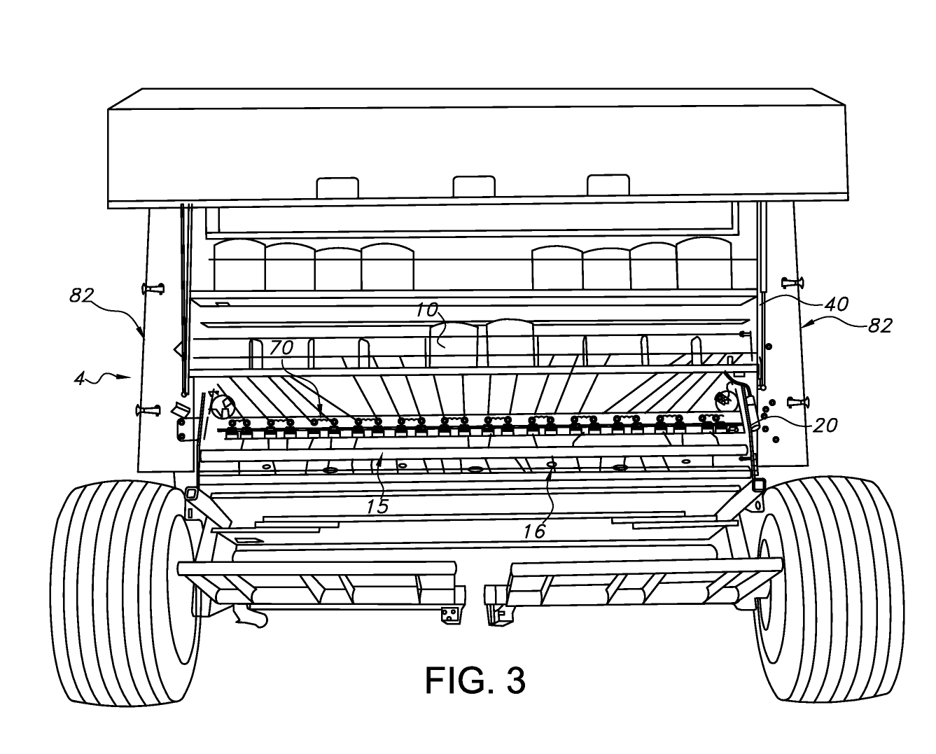

Turning to the figures, FIG. 1-3 show an example embodiment of a round baler 2 having a multiple twine wrapping apparatus 4. The wrapping apparatus 4 is disposed at the rear of the baler 2 and dispenses twine from a plurality of twine balls 10 to wrap a bale in a baling chamber of the baler 2.

The bale wrapping apparatus 4 generally includes a housing 12 having a storage area 14 for storing twine balls 10 for paying out lengths of twine strands 62 during a bale wrapping cycle of the baler 2, and a feed mechanism 16 for applying the twine strands 62 to a bale in a baling chamber. The housing 12 may have a movable hatch 22 having a rear wall 24 and hatch sidewalls 26. The hatch 22 may be pivotally attached to the tailgate 42 of the baler so as to pivot about a pivot point 30 and be supported by hatch cylinders 32 when in the open position as shown in FIG. 1.

Within the housing 12, a plurality of twine balls 10 may be arranged on spools at upper 34 and lower 36 horizontal shelves which extend between sidewalls 40 that are attached to a rear tailgate 42 of the baler 2. Divider walls 44 may be provided along the shelves 34,36 to divide the shelves into a plurality of compartments 46 for the twine balls 10 and retaining straps 50 may be provided to retain the twine balls 10 in the compartments 46. A support member 52 may extend between the sidewalls 40 to provide additional support.

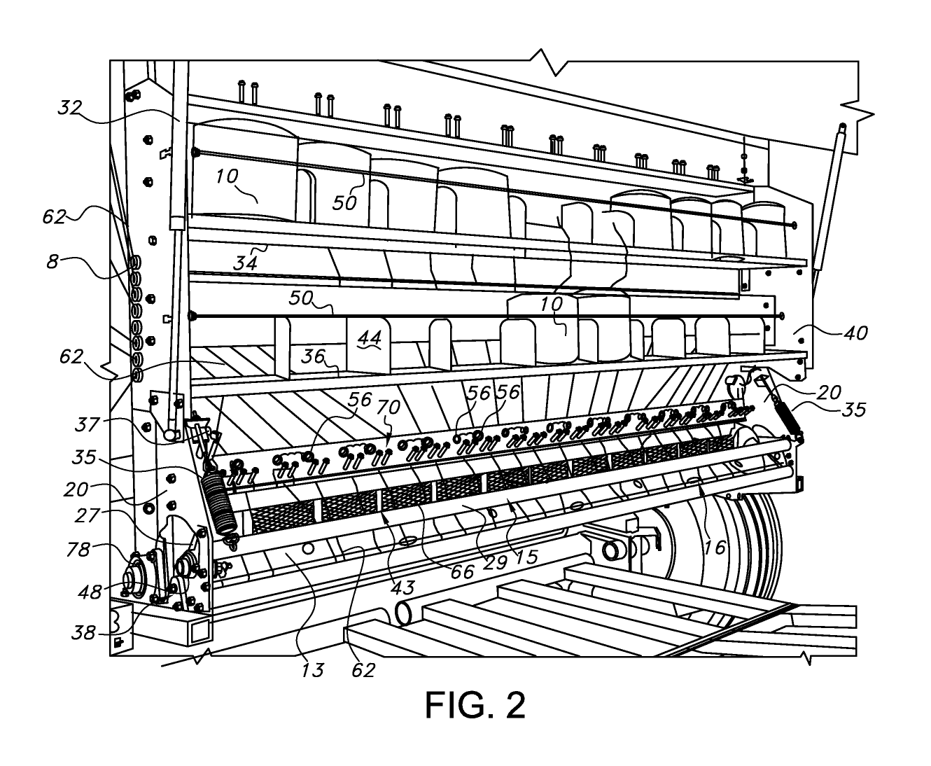

A guide mechanism 54 may include a plurality of twine positioners 56 and twine tensioners 60 to guide twine strands 62 from the twine balls 10 to a feed mechanism 16 in a manner to align the twine strands 62 with a belt stretch 64 of forming belts 66 of the baler 2. In the example embodiment shown in FIGS. 1 and 2 a manifold 70 may include a plurality of stationary twine positioners 56 and tensioners 60 that are arranged to provide a plurality of twine strands 62 in a parallel-spaced apart manner for engagement with bale forming belts 66. The twine positioners 56 are arranged so that the twine strands 62 are aligned with the bale forming belts 66. For example, two twine positioners 56 may be arranged on the manifold 70 to provide two twine strands per each bale forming belt 66. Additional tensioners 60 and positioners 56 may be provided to guide twine strands 62 to the manifold 70 from other areas about the baler 2. For example, a tensioner member 72 may extend above the twine balls 10 on the upper shelf 34 and extend between wrapper sidewalls 40.

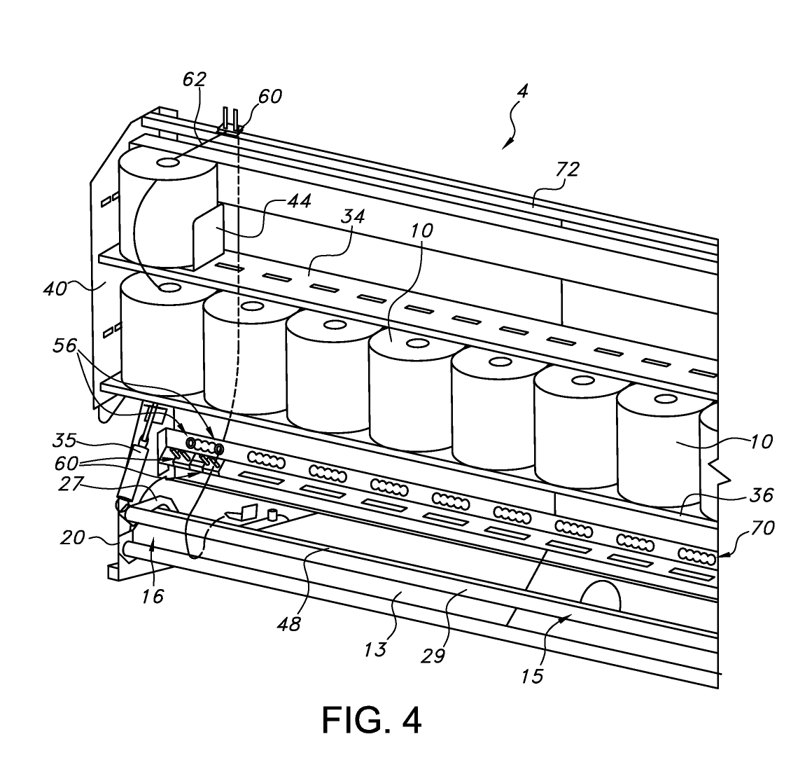

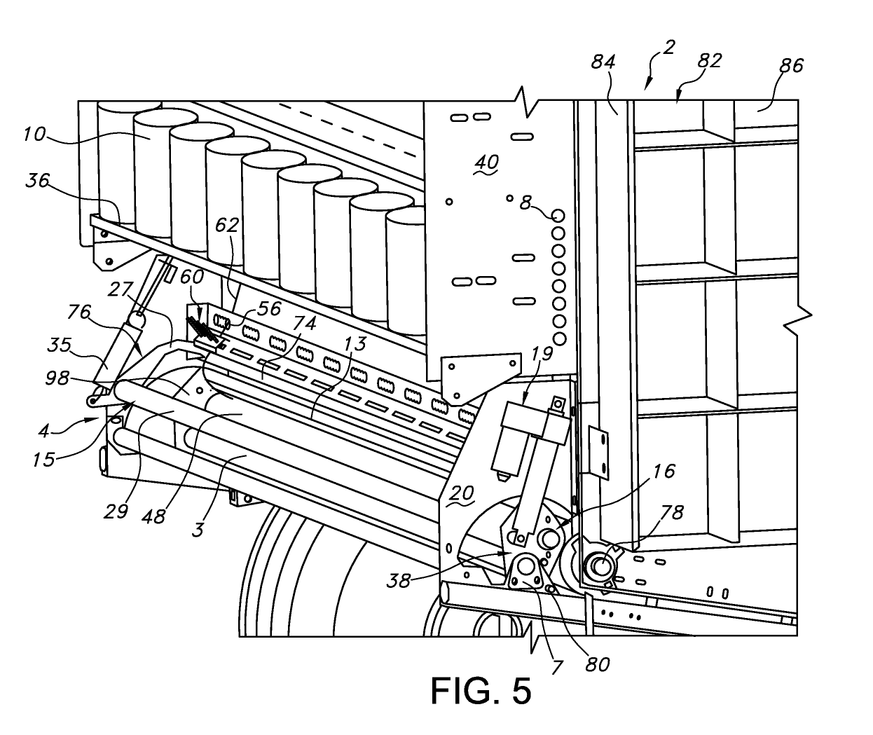

The twine strands 62 may be routed to the manifold 70 and arranged by the manifold 70 to align twine strands 62 with the bale forming belts 66. As perhaps best seen in FIGS. 4 and 5, a twine strand 62 from a twine ball 10 located on an upper shelf 34 may extend from the twine ball 10 to a tensioner 60 mounted on the transverse tension member 72. The twine strand 62 may be routed behind the transverse support member 52, behind the upper shelf 34 and the lower shelf 36, and through a twine positioner 56 on the manifold 70, through a twine tensioner 60 of the manifold 70, and around a deflector 29 of a cutoff assembly 15. As discussed in more detail below, the twine strands 62 may routed through under a guide plate 13 of a feed roller carriage assembly 16 for feeding into the baling chamber of the baler 2 through contact with bale forming belts 66.

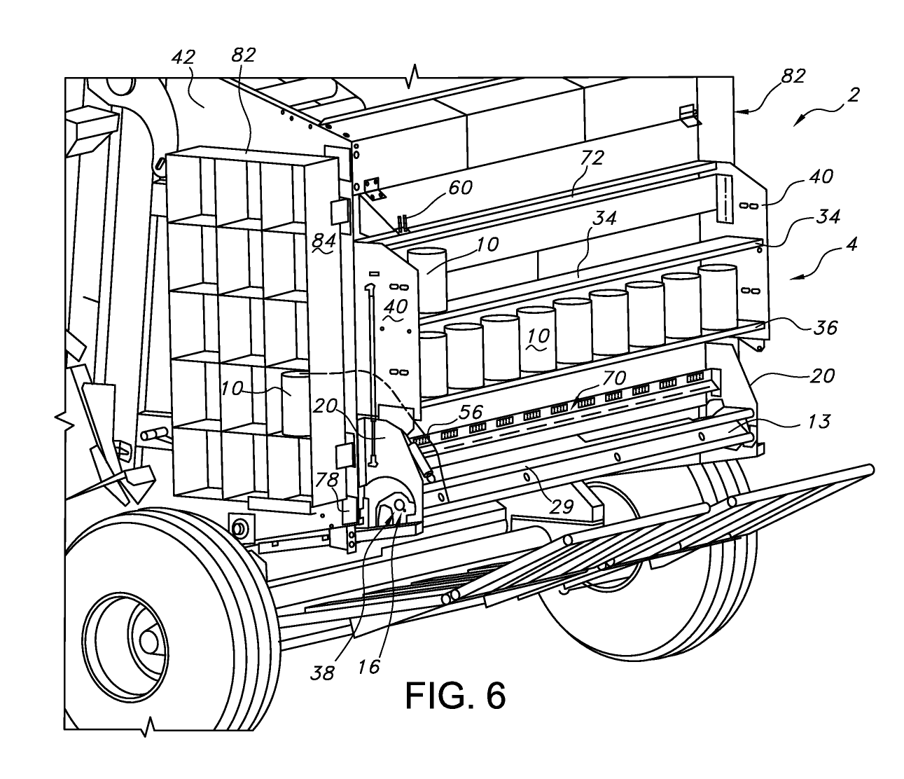

In addition to the twine balls 10 provided on the shelves 34, 36 in the housing 12, additional twine balls 10 may be provided in side cabinets 82 mounted on the side of the tailgate 42. These twine strands 62 may be guided from the cabinet twine balls 10, through positioners 56 and tensioners 60, to the manifold 70 where they pass through stationary positioners 56 for parallel alignment with twine strands 62 from other sources. The side cabinets 82 may include a housing having sidewalls 84, a rear wall 86, and a door 90. Inside the cabinets are shelves 92 and divider walls 94 which define twine ball compartments 96. A plurality of tensioners 60 may be mounted to the cabinet sidewall 84 for receiving twine strands 62 from the cabinet twine balls 10. A plurality of twine positioners 8 or guides may be provided in the wrapper sidewalls 84 for guiding twine strands 62 from the cabinet twine balls 10 to the manifold 70. As perhaps best seen in FIG. 6, twine strands 62 from the cabinet twine ball 10 may extend through a tensioner 60 mounted on the cabinet sidewall 84, through a positioner 8 in the sidewall 40, and through a positioner 56 and a tensioner 60 on the manifold 70.

As perhaps best seen in FIG. 2, the twine positioners 56 on the manifold 70 are arranged so that twine strands 62 are aligned with a stretch 64 of the bale forming belts 66 exposed at a lower portion of the tailgate 42. In the example embodiment, two positioners 56 are provided for each bale forming belt 66 to align two twine strands 62 for each belt 66. Thus, in the example shown in FIG. 2 in which the baler 2 has 12 forming belts, the manifold 70 has 24 positioners to provide 24 twine strands 62 spaced about 3.5″ apart.

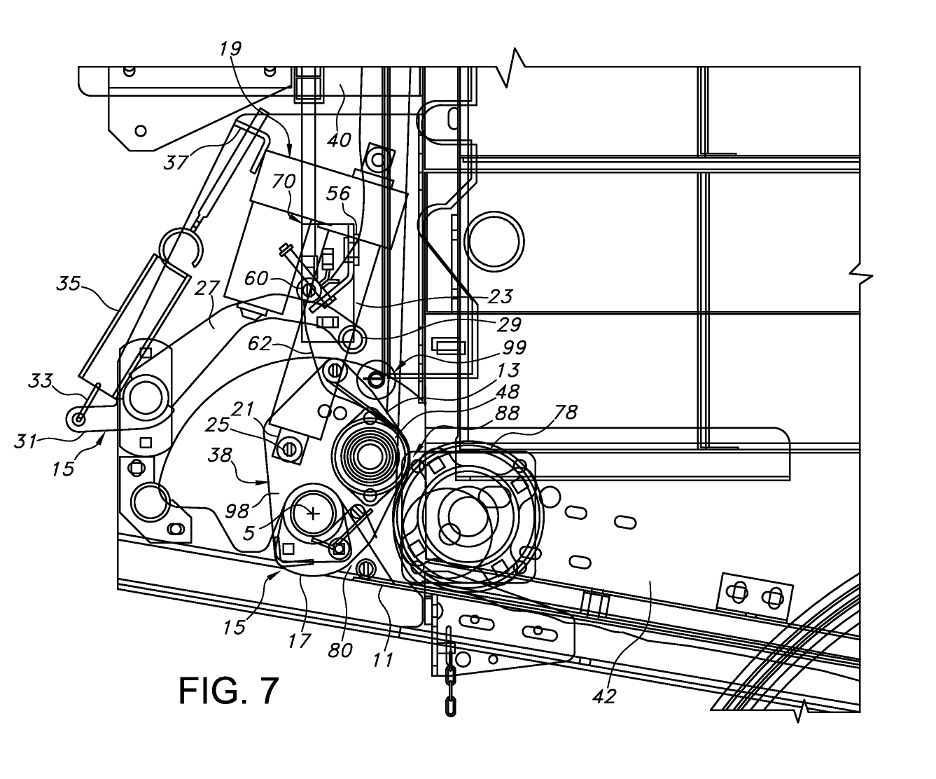

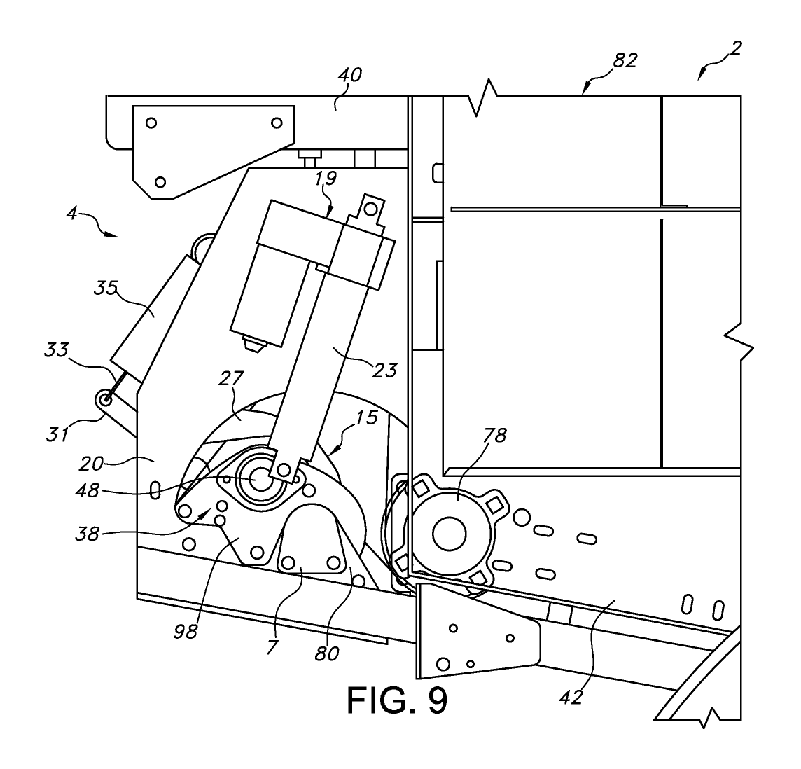

The manifold 70 provides the aligned twine strands 62 to a feed mechanism 16 configured to feed the twine strands 62 into the baling chamber to wrap a bale. The feed mechanism 16 may include a feed carriage 38 about which the twine strands 62 may be routed (FIGS. 7 and 9). The feed carriage 38 may be similar to that employed for use with meshwrap, such as the arrangement disclosed in U.S. Pat. No. 6,050,052, which is incorporated by reference herein in its entirety, and may be used for both meshwrap and twine. The feed carriage 38 may include a feed roller 48 rotatably supported on carriage sidewalls 58 by bearing assemblies 68. The periphery of the feed roller 48 may be configured to contact the periphery of a lower tailgate roller 78 to create a nip 88 therebetween. The feed carriage 38 may be supported by carriage plates 98 that are swingably supported by a pivot tube 3 journaled for rotation on wrapper sidewalls 40. The carriage plates 98 may be fixed to the pivot tube 3 for swinging movement that defines a rocking framework for supporting the feed roller 48. The feed roller carriage 38, thus pivotally supports the feed roller 48 about a pivot point 5 defined by the pivot tube 3 mounted in mount 7 on a bracket 80 of the wrapper sidewall 20.

The feed carriage 38 is movable to a feed condition in which the feed roller 48 engages the rear lower tailgate roller 78 over which the bale forming belts 66 of the baler 2 move to form a nip 88 therebetween so that twine strands 62 are pulled by the nip 88 and the forming belts 66 into the baling chamber during a wrapping cycle of the baler 2. As the forming belts 66 rotate the bale in the baling chamber the twine strands 62 wrap around the bale in a parallel spaced-apart manner to provide perpendicular to the longitudinal axis of the bale. In the feed condition, the twine strands 62 thus move through the nip 88 and between the lower tailgate roller 78 and a pan 11 so that the twine strands 62 are fed into the baling chamber to wrap around a bale. In the example embodiment shown in FIG. 1, the manifold 70 includes two positioners 56 aligned with each forming belt 66 so that two twine strands 62 are fed by the feed mechanism 16 to each bale forming belt 66. When bale wrapping is complete, the feed carriage 38 is movable to a non-feed condition in which feed roller 48 does not form a nip 88 with the bale forming belts 66 so that the twine strands 62 are not fed into the baling chamber. The feed carriage 38 also supports a guide plate 13 (FIG. 5) around which the twine 62 is fed and a cutting assembly 15 with a knife 17 for cutting the twine strands 62.

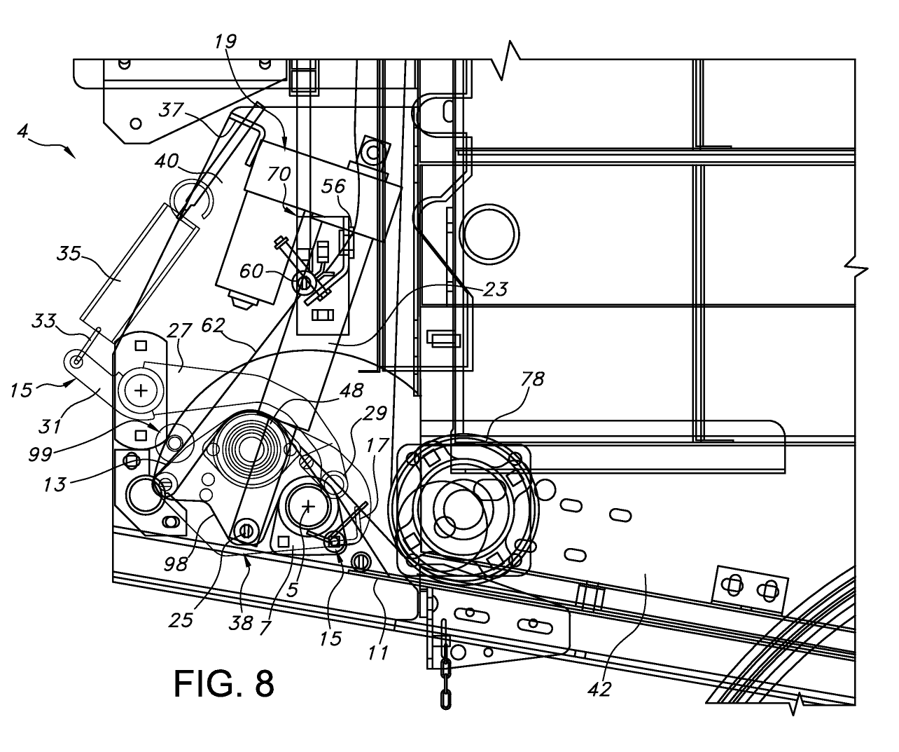

An actuator 19 may be used to move the feed carriage 38 between feed and non-feed positions. The actuator 19 may be a hydraulic piston and cylinder assembly that is coupled to the sidewall 40 and the carriage plate 98 to permit an operator to vary the range of rocking movement of the carriage plates 98. The cylinder portion 23 of the actuator 19 may be mounted to the sidewall 40 and the piston 21 connected to the carriage plate 98 by a bolt assembly 25. When the piston 21 extends, the carriage plates 98 rock rearwardly (counterclockwise in FIGS. 8-9) around pivot tube 3, while retraction of the piston 21 corresponds with forward (clockwise in FIGS. 1 and 7) rocking of the carriage plates 98. The extension of the piston 21 of the actuator 19 thus moves the carriage plates 98 to a non-feed condition (FIGS. 8-9) in which the feed roller 48 does not engage a rear tailgate roller 78 so that the twine strands 62 are not fed into the baling chamber. The retraction of the piston 21 rocks the carriage plate 98 to a feed condition (FIG. 7) in which the feed roller 48 engages the rear tailgate roller 78 of the baler 2 to create a nip 88 therebetween to feed the twine strands 62 into the baling chamber to wrap the bale. The actuator 19 may extend or retract the piston 21 in order to pivot the feed carriage 38 about the pivot point 5.

A cutoff assembly 15 may also be provided within the housing 12 for severing the twine strands 62 upon completion of a wrapping cycle. In an example embodiment, the cutoff assembly 15 is coupled with the carriage plates 98 in such a manner that operation of the cutoff assembly 15 is controlled by the rocking action of the carriage plates 98. Particularly, the cutoff assembly 15 includes a pair of arms 27 fixed adjacent opposite ends of a laterally extending pivot tube 29 which may be journaled to wrapper sidewalls 40. An extension portion 31 of the arm 27 includes holes for receiving the hook shaped end 33 of a tension spring 35. The spring 35 may be attached to the extension 33 and the wrapper sidewall 40 by a bracket 37 and bias the arms 27 in a forward (clockwise in FIGS. 7-8) direction.

A deflector 29 in the form of a hollow bar may extend between the arms 27 for selective engagement with the twine strands 62. Similar to the arms 27, movement of the deflector bar 29 is generally limited between a feed position shown in FIGS. 5 and 7 and a cutting position shown in FIG. 8. The deflector 29 moves from a disengaged position to a cutting position to engage the twine 62 and deflect the twine 62 out of its normal path of travel and against a knife 17 to sever the twine 62. In this respect, the cutoff assembly 15 is configured to sever the twine 62 as the carriage plates 98 swing rearwardly from the feeding position shown in FIG. 7 to a non-feed position shown in FIG. 8.

The carriage plates 98 and the cutoff arms 27 may be shaped so that when the feed roller 48 is in the feed position, the extension arm 27 is moved out of the way of the twine 62.

For example, a guide plate 13 may be provide on the feed carriage 38 and the twine strands 62 routed under the guide plate 13 when the feed carriage 38 is in the feed position. The guide plate 13 also assists in keeping the twine strands 62 aligned with the forming belts 66. Thus, twine strands 62 are fed behind the deflector bar 29 and under the guide plate 13 in the feed condition to the nip 88. The cutoff assembly 15 is held upwards against the tension of the springs 35 by cutoff positioning roller 99, which is a bearing attached to the feed carriage 38 that rolls along extension arm 27 and forced it upwards when the feed carriage 38 is in the feed position. When the actuator piston 21 is extended, the feed carriage 38 is rotated counter clockwise from the feed position (FIG. 7) to the cutoff position (FIG. 8) and the deflector bar 29 moves clockwise to push the twine strands 62 against the knife 17, which is now pointing upwards on the feed carriage 38 to cut the strands 62.

As discussed above, during a feed condition, the twine strands 62 are fed behind the guide plate 13, through the nip 88, and along the pan 11 to enter the baling chamber to wrap the bale. The knife 17 may comprise a relatively flat blade mounted on the feed carriage 38 so that in a feed condition (FIG. 7) the knife 17 is positioned away from the rear tailgate roller 78. As the feed carriage 38 moves to a cutoff position by the extension of the piston 21, the knife 17 moves upward into the position shown in FIG. 8. The cutoff assembly 15 rotates about the pivot point 5 (clockwise in FIG. 7) and the deflector bar 29 engages a kicker plate 41 as the deflector bar 29 swings from a disengaged position to a cutting position. The deflector bar 29 pins the twine strands 62 against the pivot tube 3 which serves as a stop to prevent movement of the deflector bar 29 in this direction beyond the position shown in FIG. 8 this serves to clamp the twine 62 between the deflector bar 29 and the pivot tube 3 once the twine strands 62 have been severed. The guide plate 13 moves rearward and pulls the twine 62 taught.

Thus, as shown in FIG. 7, it can be seen that when the feed roller 48 is in the feed position the twine strands 62 extend downwardly from a twine ball 10, through a positioner 56 and tensioner 60 on the manifold 70, behind the deflector 29 of the cutoff assembly 15, around and under the guide plate 13 and around the feed roller 48 which is in engagement with rearward most belt stretch 64, creating a temporary nip 88 therebetween. The twine 62 is pulled downstream by the rearward most belt stretch 64 along a pan 11 that extends generally between the rearward most belt stretch 64 and the tailgate roll 78. The pan 11 is spaced slightly below belts 66 as they travel so that the belts 66 convey the twine along the pan into a chamber inlet where it wraps around a formed bale.

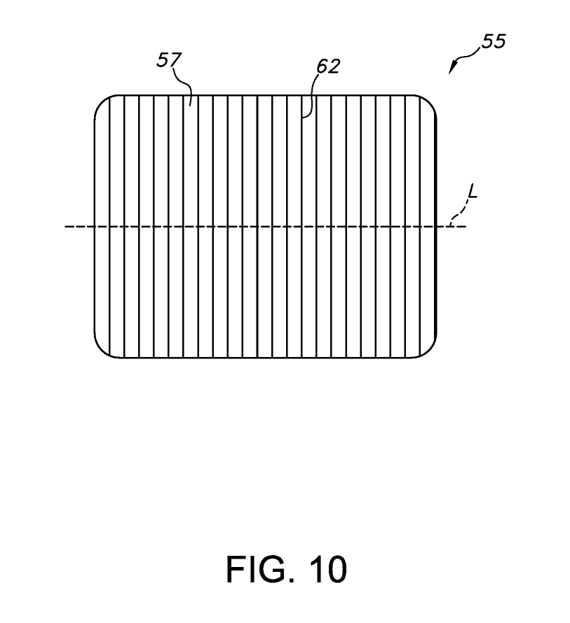

The twine strands 62 are thus applied to the bale in the baling chamber in a parallel-spaced apart manner from stationary positions to wrap the bale as shown in FIG. 10. The positioners 56 on the manifold 70 may be located so as to provide twine strands 62 to the forming belts 66 and avoid the spaces 43 between the belts 66. For example, the manifold 70 may have positioners 56 spaced 3.5″ apart to provide two twine strands for each of 12 forming belts 66 for a bale wrapped with 24 individual twine strands 62 through three revolutions of the bale in the baling chamber.

The bale may be rotated through a plurality of revolutions by the bale forming belts 66 of the baling chamber. The use of multiple twine strands that are stationary along the longitudinal axis of the bale allows the bale to be wrapped in just a few bale revolutions. While the bale may be wrapped any number of times, Applicant has found that three revolutions is sufficient for wrapping, a significant decrease from traditional twine wrapping arrangements.

FIG. 10 shows an example embodiment of a wrapped bale 55 in which a round bale 57 is wrapped with a plurality of separate twine strands 62. The twine is arranged in separate strands perpendicular to the longitudinal axis L of the bale 57 and the twine strands do not extend longitudinally down the bale.

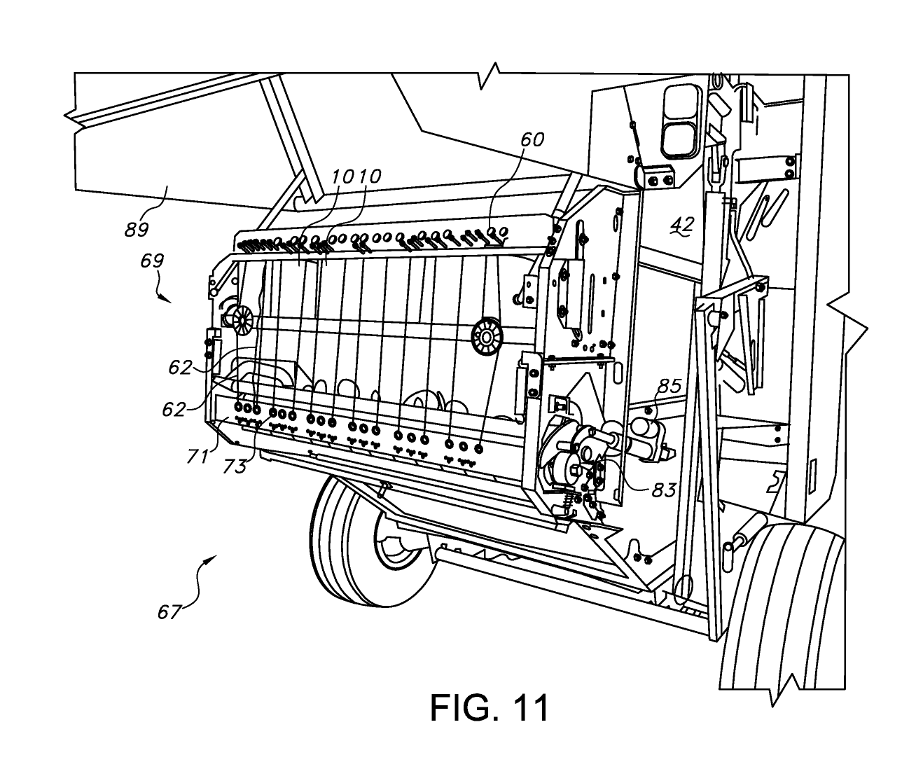

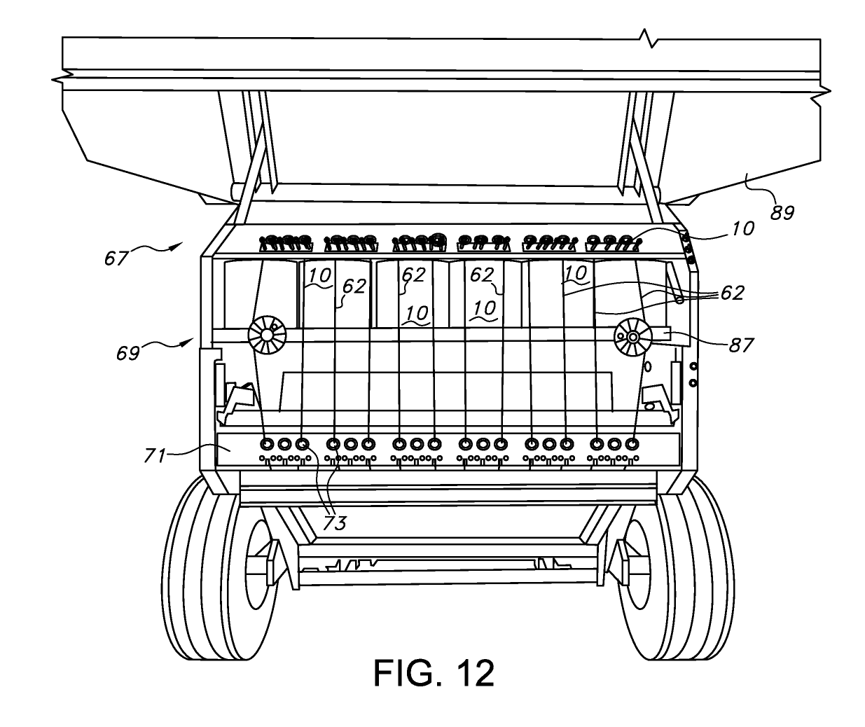

FIGS. 11 and 12 show another example embodiment of a small round baler 67 having a multi-twine wrapping apparatus 69 having tensioners 81 and a manifold 71 with twine positioners 73 for routing twine 62 from twine balls 10 and a feed mechanism 83 rockable by an actuator 85. A single shelf 87 may hold twine balls in a two-deep arrangement, providing for twelve twine balls in the embodiment shown. The wrapping apparatus 69 may be located at the rear of the baler 67 and include a hatch 89. The positioners 73 may be arranged to align the twine strands 62 with bale forming belts of the baler 67 and fed into the baling chamber through the feed mechanism 83.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

What is claimed is:

1. A wrapping system for a round baler comprising a stationary guide arrangement configured to apply a plurality of twine strands from a stationary position to a bale forming chamber of a baler to wrap a bale with the plurality of twine strands.

2. The wrapping system of claim 1, wherein the stationary guide arrangement comprises a manifold configured to align the plurality of twine strands with bale forming belts of the baler.

3. The wrapping system of claim 2, wherein the manifold extends across a rear of the baler.

4. The wrapping system of claim 1 further comprising a feed mechanism configured to feed the plurality of twine strands from a twine source to the bale forming chamber.

5. The wrapping system of claim 4, wherein the feed mechanism comprises a feed roller configured to create a nip with the bale forming belt so that twine strands are fed into a bale forming chamber of the baler to wrap a bale.

6. The wrapping system of claim 1, wherein at least six strands of twine are fed simultaneously.

7. The wrapping system of claim 1, wherein the guide system is configured to provide at least two twine strands to a single bale forming belt.

8. The wrapping apparatus of claim 1, further comprising a cutoff mechanism configured to cut the plurality of twine strands.

9. The wrapping apparatus of claim 1 further comprising a twine ball storage cabinet provided at a side of the baler.

10. An apparatus, comprising:
a baler having a plurality of bale forming belts for forming a bale;
a twine feed mechanism for feeding a plurality of twine strands to a baling chamber; and
a guide arrangement configured to align the plurality of twine strands with the bale forming belts and route the twine strands to the twine feed mechanism, the guide arrangement stationary with respect to the bale to wrap the bale with a plurality of twine strands perpendicular to the longitudinal axis of the bale.

11. A method, comprising applying a plurality of twine strands to a bale in a baling chamber of a baler from stationary positions relative to the bale.

12. The method of claim 11, further comprising aligning a plurality of twine strands to bale forming belts of a baler positioned for the wrapping of a bale in a baling chamber formed by the bale forming belts.

13. The method of claim 11, further comprising wrapping a bale in the baling chamber with the plurality of twin strands.

14. The method of claim 11, further comprising wrapping a bale in the bale forming chamber with the plurality of twine strands from a stationary position relative the bale.

15. The method of claim 11, further comprising wrapping a bale in the bale forming chamber with a plurality of twine strands perpendicular to the longitudinal axis of the bale.
